(19) United States
(12) Patent Application Publication
(10) Pub. No.: US 2023/0029218 A1
(43) Pub. Date: Jan. 26, 2023

(54) FEATURE ENGINEERING USING INTERACTIVE LEARNING BETWEEN STRUCTURED AND UNSTRUCTURED DATA

(71) Applicant: International Business Machines Corporation, Armonk, NY (US)

(72) Inventors: Anuradha Bhamidipaty, Yorktown Heights, NY (US); Yingjie Li, Chappaqua, NY (US); Shuxin Lin, White Plains, NY (US); Zhengliang Xue, Yorktown Heights, NY (US); Bhavna Agrawal, Armonk, NY (US)

(21) Appl. No.: 17/380,189

(22) Filed: Jul. 20, 2021

(51) Int. Cl. G06N 20/20; G06K 9/62; G06F 40/40

(52) U.S. Cl. CPC G06N 20/20; G06K 9/6202; G06K 9/6262; G06K 9/6288; G06K 9/6296; G06F 40/40

(57) ABSTRACT

A concept associated with a feature used in machine learning model can be determined, the feature extracted from a first data source. A second data source containing the concept can be identified. An additional feature can be generated by performing a natural language processing on the second data source. The feature and the additional feature can be merged. A second machine learning model can be generated, which use the merged feature. A prediction result of the first machine learning model can be compared with a prediction result of the second machine learning model relative to ground truth data, to evaluate effective of the merged feature. Based on the evaluated effectiveness, the feature can be augmented with the merged feature in machine learning.

### BACKGROUND

The present application relates generally to computers and computer applications, and more particularly to machine learning and improving feature engineering.

Feature engineering for machine learning (ML) extracts features from data or raw data, for example, based on domain knowledge. For instance, an automated or semi-automated machine learning modeling pipeline can include problem formulation, data acquisition, data cleaning and curation, feature engineering and model selection and tuning. Feature engineering, as a part of any machine learning procedure, impacts the accuracy of a model that is built. Source of data for feature selection can include structured or unstructured data sources.

However, sometimes even when the value of a feature is recognized from a data source type (e.g., structured source), the actual data needed for modeling the feature might not be available from that source, or even if available such available data might be incomplete. This problem can be further accentuated in automated artificial intelligence (AI) modeling pipelines, where the lack of data can lead to the feature not being used at all, or lead to the feature being imputed insufficiently, impacting the model accuracy.

### BRIEF SUMMARY

The summary of the disclosure is given to aid understanding of a computer system and method of feature engineering, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A system for feature engineering in a machine learning pipeline, in an aspect, can include a processor and a memory device coupled with the processor. The processor can be configured to receive a feature extracted from a first data source, where the feature is used in a first machine learning model and where the first machine learning model is built to predict an outcome. The processor can also be configured to determine a concept associated with the feature by traversing a concept graph. The processor can also be configured to identify a second data source containing the concept associated with the feature. The processor can also be configured to generate an additional feature by performing a natural language processing on the second data source. The processor can also be configured to merge the feature and the additional feature. The processor can also be configured to generate a second machine learning model for predicting the outcome using the merged feature. The processor can also be configured to run the second machine learning model. The processor can also be configured to compare a prediction result of the first machine learning model with a prediction result of the second machine learning model relative to ground truth data, to evaluate effective of the merged feature. The processor can also be configured to, based on the evaluated effectiveness, augment the feature using the merged feature in machine learning.

A method of feature engineering in a machine learning pipeline, in an aspect, can include receiving a feature extracted from a first data source, where the feature is used in a first machine learning model, and where the first machine learning model is built to predict an outcome. The method can also include determining a concept associated with the feature by traversing a concept graph. The method can also include identifying a second data source containing the concept associated with the feature. The method can also include generating an additional feature by performing a natural language processing on the second data source. The method can also include merging the feature and the additional feature. The method can also include generating a second machine learning model for predicting the outcome using the merged feature. The method can also include running the second machine learning model. The method can also include comparing a prediction result of the first machine learning model with a prediction result of the second machine learning model relative to ground truth data, to evaluate effective of the merged feature. The method can also include, based on the evaluated effectiveness, augmenting the feature using the merged feature in machine learning.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating structured and unstructured data in model development in an embodiment.

FIG. 2 is a flow diagram illustrating interactive learning of features in an embodiment.

FIG. 3 is a flow diagram illustrating feature engineering with interactive learning in an embodiment.

FIG. 4 is a diagram illustrating a tool interface for feature engineering in an embodiment.

FIG. 5 is a flow diagram illustrating a method in an embodiment.

FIG. 6 is a diagram showing components of a system in one embodiment that perform feature engineering in a machine learning pipeline.

FIG. 7 illustrates a schematic of an example computer or processing system that may implement a system according to one embodiment.

FIG. 8 illustrates a cloud computing environment in one embodiment.

FIG. 9 illustrates a set of functional abstraction layers provided by cloud computing environment in one embodiment of the present disclosure.

### DETAILED DESCRIPTION

A system, method and technique are disclosed to iteratively improve feature engineering. In one or more embodiments, a system and/or method may interactively learn the features across different types of data sources (e.g., from structured to unstructured) and use those features to improve the model. For example, the system and/or method may interactively learn features from structured and unstructured data in an automated machine learning pipeline. In an embodiment, to look for new features in addition to existing features, structured data can be augmented with features from unstructured data using natural language processing (NLP).

Feature engineering extracts features from data, e.g., from raw data which may be available from one or more data sources. The extracted features are used in architecting a machine learning model such as a neural network model or another artificial intelligence or machine learning model. In some instance, there can be insufficiency in available data, e.g., not enough data may be directly available from the original data sources to fully implement a feature.

Interactive learning of features across heterogenous data sources can augment the feature set to improve accuracy of machine learning models. In an embodiment, a system and/or method interactively learns features between structured and unstructured data sources to bridge the gap between the desired concept and the data needed for the machine learning. For example, consider that a desired feature includes “advanced industry development” for predicting the growth of a locale. Consider also that there is not enough data in structured data sources to predict the advanced industry development. One of the proxies or substitutes for advanced industry development can be identified from one or more unstructured data sources storing information such as current job openings in the advanced industries in the area. The system and/or method in an embodiment can identify a new source, for example, an unstructured data source and extract (or formulate) one or more new variables from the new source as one or more features to incorporate into a machine learning model. In an embodiment, a new feature can be incorporated in the model by concept mapping. Concept mapping identifies concepts in one set of data (e.g., structured data) and maps the identified concepts to related concepts in another set of data (e.g., unstructured data).

A concept map (also referred to as a knowledge graph or concept graph) can be structured as a graph (or graph data structure) including nodes and edges connecting the related nodes. A node in a graph can represent a concept, and edges connect the nodes (representing concepts) based on the relationship between the concepts. A node representing a concept can also include one or more attributes (e.g., metadata or information about the concept). An edge connecting two nodes can be weighted, e.g., based on the strength of the relationship, or another factor. The graph can be traversed using any one or more graph traversal techniques such as depth-first, breadth-first, and/or others.

In an embodiment, a new feature can be incorporated by gap filling. Gap filling augments the data in spatial and temporal dimension, using concept mapping between structured and unstructured data to provide the missing data in a set. By way of example, consider that a feature determined to be important is “tourism” for machine learning modeling for predicting the growth of a locale. A concept map or graph such as a knowledge graph can be traversed, e.g., starting with “tourism” node to uncover related concepts for use as features in machine learning. Concepts associated with “tourism” can include “flights”, “travelers” and “expenses”, “sentiment on social media”, “trending highlights” and “tourism bottleneck”. Such related concepts can be found as structured data and/or unstructured data. For example, information or data associated with “flights”, “travelers”, “expenses” can be found as structured data; information or data associated with “sentiment on social media”, “trending highlights” and “tourism bottleneck” can be found as unstructured data, for example, in free text documents or like. As another example, structured data can be found that is available, which includes combined tourism data for two cities. In unstructured data such as from social media, news, entertainment information for each city, separated data can be found for those cities.

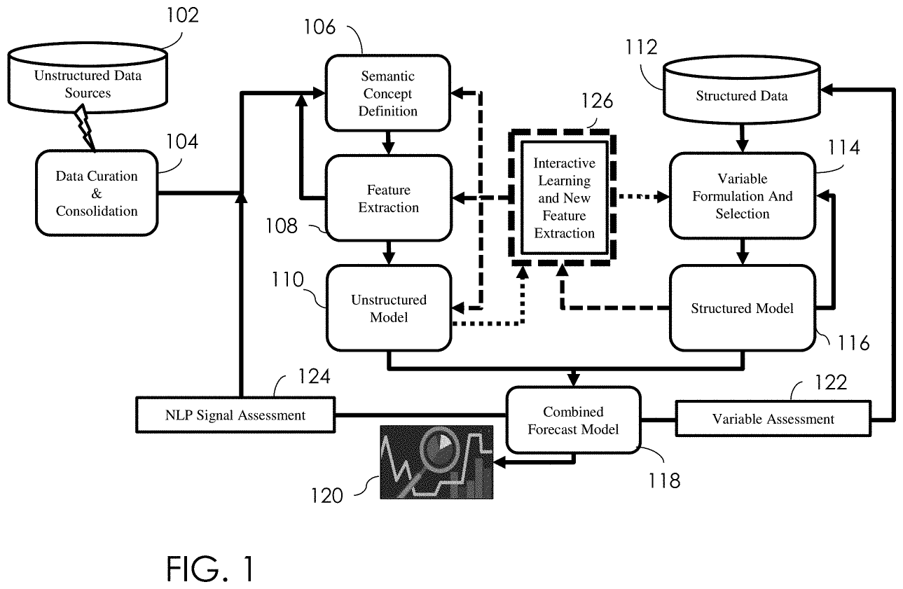

FIG. 1 is a diagram illustrating structured and unstructured data in model development in an embodiment. The components shown include computer-implemented components, for instance, implemented and/or run on one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

Unstructured data 102 can be received from one or more unstructured data sources. At 104, a processor may curate and consolidate the unstructured data. Unstructured data can include, but not limited to, free text data, for example, in natural language form. For example, curating and consolidating at 104 can include collecting data from diverse sources, integrating and/or organizing it into one or more repositories, cleaning data of undesired characters, meta data tags, etc., e.g., so that the data can be maintained and managed over time, and can be easily processed by NLP techniques.

At 106, a domain expert can define relevant semantic concepts of the unstructured data, or these semantic concepts can come from the structured model, once an initial structured model has been built.

At 108, a processor can, e.g., semi-automatically, extract features related to the above concepts from the unstructured data using NLP techniques such as concept identification, category classification, sentiment and emotion analysis etc.

At 110, a processor can build a forecasting model such as Auto-Regressive Distributed Lag (ARDL) model, based on the unstructured features from 108. The resulting model can identify NLP parameters that can be combined with the structured model parameters, and can also be used to further identify additional structured variables.

Structured data 112 can be received. Structured data can include data that is formatted, e.g., according to a data model and/or identifiable structure. At 114, a processor may perform variable formulation and selection, e.g., using domain expertise, normalization, and correlation analyses. Variable formulation and selection at 114 can include selecting variables as features to use in machine learning modeling. At 116, structured forecasting model, based only on structured variables can be built using one or more ARDL techniques.

At 118, a processor may build and run a combined forecasting model using the unstructured and structured variables. The combined forecast model outputs results 120.

At 122, based on the results, a processor may perform variable assessment. In an embodiment, a variable assessment can be performed using significance probabilities (p-values). For instance, a processor may evaluate the structured data used in the combined forecast model for its goodness, e.g., whether it helped the model to perform an accurate forecast, prediction or classification. Based on the assessment, the processing may repeat at 112.

At 124, a processor may perform NLP signal assessment, e.g., using significance probabilities (p-values). For instance, a processor may evaluate the unstructured data used in the combined forecast model for its goodness, e.g., whether it helped the model to perform an accurate forecast, prediction, or classification. The assessment information can be fed back and the process at 106 can be repeat.

Interactive learning and new feature extraction at 126 determines which new features from structured data and unstructured data sources need to be derived to augment the existing variables using gap-filling techniques or to add additional variables using concept-mapping techniques.

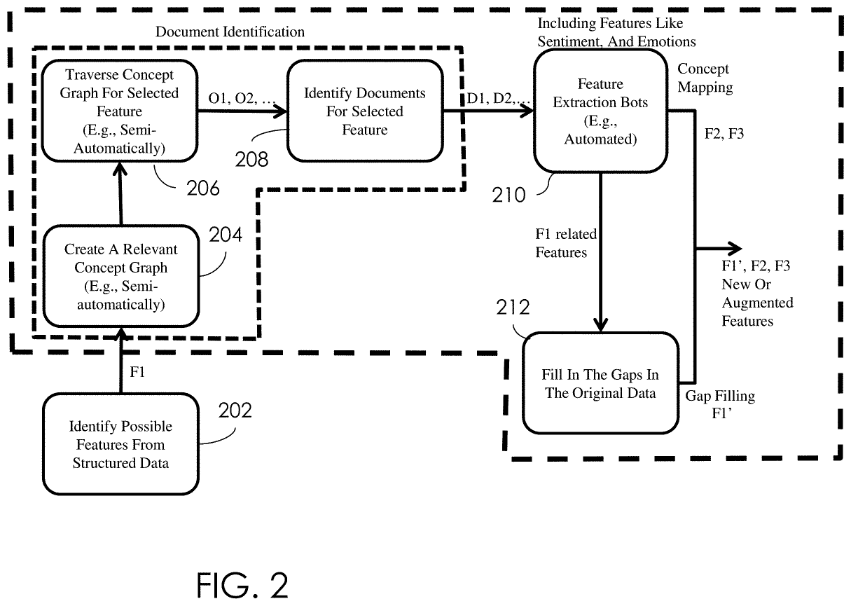

FIG. 2 is a flow diagram illustrating interactive learning of features in an embodiment. A processor may perform document identification, for example, identify documents from which to extract one or more features. In an embodiment, the documents may be directly available for feature extraction. For example, if a processor is searching for one or more travel related features, the processor may have access to travel related documents, from news, social medial, and/or another, and the processor may proceed to feature extraction directly.

In another embodiment, a processor may have related one or more concept graphs available, for example, from a database or data cataloging platform, for example, which are available to developers and consumers. The processor can identify documents related to those concepts from a given corpus of documents, and then proceed to feature extraction. For example, for features related to advanced industry development, the processor may have access to concepts related to it, such as jobs in those industries, investment in those industries, new businesses opening in those industries, and/or others, e.g., based on traversing one or more concept graphs. The processor can collect documents related to those concepts from news sources, classified advertisements, and others, and proceed to feature extraction.

In an embodiment, a processor may not have a related concept graph available, in which case, the processor may develop a concept graph for the concept of interest using one or more available techniques. For example, one or more NLP techniques can be used to identify semantics of words and link them to create concept graphs. Other techniques can be used. Using the concept graph, additional features can be uncovered or extracted, and values associated with those features can be extracted from associated documents from a corpus of available documents such as news, social media, and/or other databases.

At 202, a processor may identify possible features from structured data. For instance, a variable in the structured data can be selected, which can be related to a feature already being used in modeling a machine learning model. As another example, a feature from structured data can be given. As another example, a model can be run using structured data as features, p-values associated with those features can be generated, and the statistical significance of those features can be measured in a variety of ways. As an example, n number of lowest p-value features can be selected or identified, where “n” can be configurable or predefined. Briefly, in statistics, the p-value is the probability of obtaining test results at least as extreme as the results actually observed, under the assumption that the null hypothesis is correct. A small p-value associated with a feature indicates that the feature is very relevant to the model. In FIG. 2, this identified feature from the structured data is shown as “F1”. By way of example, an identified feature can be “tourism”.

At 204, if no concept graph or knowledge graph is available, a concept graph can be created. For instance, using words or terms appearing or used in the general topic or subject area of the machine learning model, nodes of a graph can be created, which represent those words or terms, and semantically related nodes can be connected via edges in the graph. Known NLP and other techniques can be used to create such concept graph. For example, a concept graph may be created using WordNet (e.g., a lexical database of semantic relations between words) and VerbNet (e.g., on-line or digital network of verbs that links syntactic and semantic patterns of verbs, or verb lexicon), where the words are connected to each other using relationships, and closely connected words are conceptually closer to each other.

At 206, a processor may traverse a concept graph, for example, a concept graph newly created at 204 if not available, or an available concept graph, and extract related concepts. For instance, one or more nodes representing terms or words, which are connected or linked to a node of the identified feature, can be identified. In an embodiment, one or more nodes linked to the identified feature node by a threshold number of edge distance can be identified. By way of example, consider that the identified feature at 202 is “tourism”. A processor may find a node in the concept graph that represents “tourism” and starting from that node, traverse the graph and find other nodes that are connected to “tourism” node. For instance, all nodes directly connected to the “tourism” node can be identified. In another aspect, all nodes connected by n number of edges can be identified, where “n” is a number or distance that can be preconfigured. The words or terms represented by the identified nodes can be considered related concepts. One or more such related concepts can be identified. In FIG. 2, the identified related concepts are shown as “O1”, “O2”, and so on.

At 208, a processor may identify documents, e.g., from one or more databases or repositories of documents, which may be given, associated with the identified concepts using NLP techniques, such as category and concept extraction of documents, or document similarity techniques if an initial relevant document is identified by an expert. For instance, a processor may search a social media database, news database, and/or one or more other databases for documents that contain or use the words or terms of the related concepts (e.g., “O1”, “O2”, and so on, and/or “F1”. In FIG. 2, the identified documents are shown are “D1”, “D2”, and so on.

At 210, a processor, for example, a feature extraction bot or another, may extract additional features in the documents, “F2”, “F3”, such as popularity of related concepts, sentiments, emotions, relationships to other entities, etc., that can be used directly as new features. The processor at 210, may also extract “F1 related features” that can be used to enhance the original feature F1 using gap-filling techniques of 212. By way of example, if number of tourists in a town was the original (F1) parameter, and if it was not available for two cities separately but only as a total for two cities, then “F1 related parameters” could be real time tourism-related updates for each of the cities in a social media platform, and this information could be used to derive the number of tourists for each city. The extracted features can be used in modeling a machine learning model.

At 212, a processor may perform gap filling using the extracted additional F1 related features. For instance, F1 related parameters may provide information to fill the gaps in structured information in spatial and/or temporal dimension. By way of example, if structured data had number of tourists information only up to previous year, and information for current year is desired, the processor may use the features derived from tourism information on social media platforms to predict the number for this year.

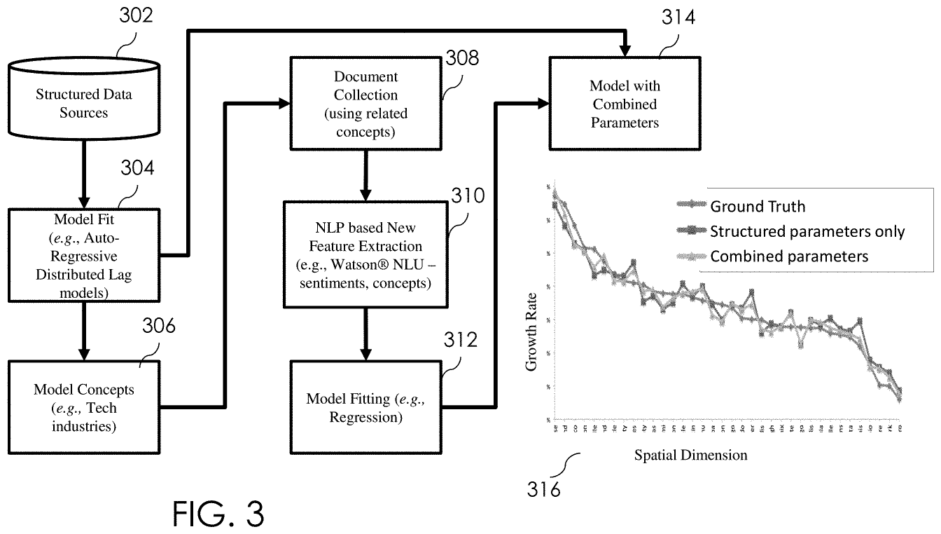

FIG. 3 is a flow diagram illustrating feature engineering with interactive learning in an embodiment. One or more computer processors or hardware processors can run or implement the flow. By way of example, only, the process flow shown in FIG. 3 is described with reference to an example of building a machine learning model for city growth over time for multiple cities. It should be understood, however, that the flow shown in FIG. 3 can work with any other machine learning model development or pipeline.

Structured data 302 may include any data such as numerical data relevant to a given prediction model. For example, for a city growth model, it may be gross domestic product (GDP) (e.g., yearly or monthly), population data, employment data, migration data, transportation infrastructure, tourism, and/or others. This may be stored in a tabular form in a text or another spreadsheet file, or in a database.

At 304, a processor receives input from 302, and runs the input through a predictive model, such as an Auto-Regressive Distributed Lag (ARDL) model for spatio-temporal data, to generate the predictions in spatio-temporal dimensions. Example of generated predictions are shown at 316. The model also produces the significance of various input variables for the input (e.g., using p-values).

At 306, based on information from 304, for example, the significance of various input variables used in the model run, a processor determines one or more variables to enhance using unstructured data sources. For instance, in an embodiment, the processor may evaluate p-values, and decide to augment variables with high p-values (e.g., p-values that exceed a predefined threshold value can be determined to be “high p-values”), the variables that do not currently show a significant impact on the model, or if the processor knows a-priori one or more variables that do not have good data, the processor may decide to augment such variables. Once the variable is determined, the processor can derive concepts related to the variable using a concept graph (e.g., including automated concept graph generation technique, if not available), or using a domain knowledge. For example, for “Tech Industry Development” (as an example of a feature from structured data used in modeling), the processor can look for new business openings and discussions in business news media (as an example of unstructured data) in Tech areas, job opening (as an example of unstructured data) in Tech industries, and so on. Concept mapping can include the process of finding new features using related concepts, for example, including, but not limited to, mapping concepts from structured to unstructured data.

At 308, a processor may use one or more concepts mapped from one or more variables at 306, to generate or collect possible relevant documents from a given corpus of documents or database of documents. For example, news articles relevant to tech industry might be a good source (these documents can be supplied by another data source, or the processor can classify general news documents as being relevant or irrelevant using one of the many Natural Language classification techniques).

At 310, using the documents from 308, the processor can further extract features from the documents, e.g., using techniques such as natural language processing (NLP) techniques to extract sentiments, concepts, topics, and/or the like. The processor can extract data like sentiments reflected in the documents for investment in tech industry (as an example of a feature from unstructured data), number of job openings in tech industry compared to the rest (as an example of a feature from unstructured data), the trends over time (and cities if needed) of these data (as an example of a feature from unstructured data), and/or others.

At 312, using the features extracted at 310, the processor can develop another predictive model to understand the efficacy of these features (e.g. a simple regression model). The model at 312 can have similar architecture of the model at 304, but with different or additional input feature set. The models at 312 and 304 can be models for producing the same output, e.g., predicting locality growth. In an embodiment, variables with lowest p-values can be chosen as good fit. For instance, variables with n lowest p-values can be chosen, where n can be a configurable or predefined number. As another example, all variables with sufficient low p-values (e.g., p-value less than a predefined threshold) can be chosen, where a threshold is applied to identify the statistically significant variables.

At 314, using the good fit variables from 312, and structured variables from 304, the processor can generate or develop a combined model to generate results, e.g., a model that provides values closest to ground truth. At 316, data are shown of ground truth, output of a model with structured parameters only, and output of the model with combined structured and unstructured parameters. In an embodiment, the model at 304 uses only structured variables, the model at 312 uses only unstructured variables, and the model at 314 uses both structured and unstructured variables, e.g., taking the best or most relevant variables from both models at 304 and 312 to generate a combined model.

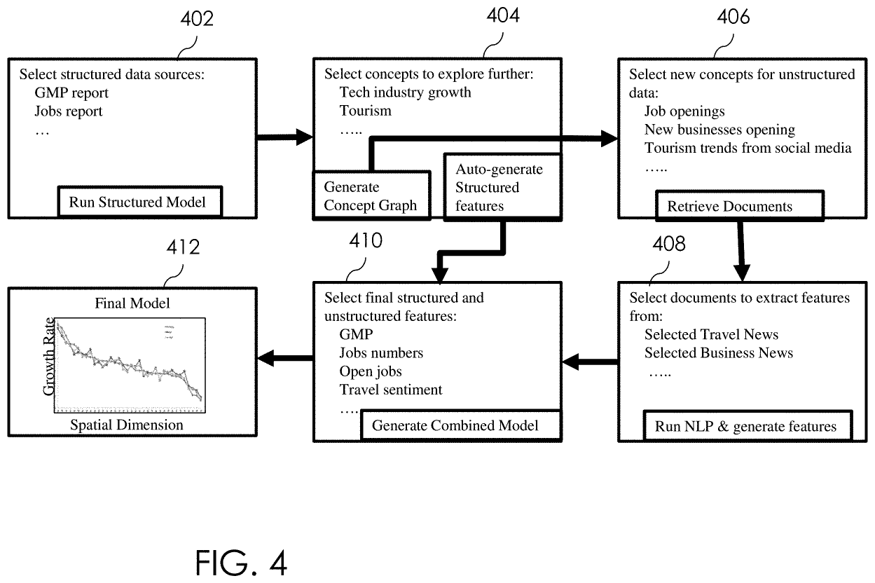

FIG. 4 is a diagram illustrating a tool interface showing a process of feature engineering in an embodiment. One or more computer processors can implement or run the process. In an embodiment, the process can run completely automatically. In another embodiment, the process can run semi-automatically, for example, based on one or more input choices from a user. At 402, structured data sources can be selected. Structured data sources can be input by a user, or a processor may start with an initial set of given structured data sources. Using structured data from those sources as features, a machine learning model can be generated. An example of a machine learning model can be one that learns to predict a city's or locale's growth based on input features.

At 404, concepts to explore further can be selected. For example, starting from a node representing a feature selected from the structured data, a concept graph can be traversed to identify one or more concepts associated with that feature. For instance, concepts represented in nodes connected to the node representing the feature can be identified. In an embodiment, if no concept graph is available, a concept graph can be built. In an embodiment, based on traversing the concept graph, additional structured data features can be automatically generated. For instance, if the related concepts identified during concept graph traversal uncovers additional features which are available as structured data (e.g., from the structured data sources), those features can also be used in building a machine learning model.

At 406, new concepts for unstructured data can be selected. For instance, if data associated with the related concepts identified during concept graph traversal are not available as structured data, unstructured documents can be searched for, or identified, which describe or have information about those concepts. Those documents can be retrieved. In an embodiment, a user may select possible concepts for unstructured data, or a processor may automatically select those concepts. In an embodiment, a user may select documents to retrieve, or a processor may automatically select and retrieve documents.

At 408, one or more of the retrieved documents can be selected for extracting features. A natural language processing (NLP) technique, for example, can be utilized to extract or generate features from those documents.

At 410, one or more of the structured data (e.g., from 404) and one or more of the unstructured data (e.g., from 408) can be used as features for building a machine learning model. At 412, the built machine learning model using both the structured and unstructured data can be run, which generates an output. A machine learning model using only the structured data (e.g., from 404) can also be built and run. The output of the machine learning model using only the structured data and the output of the machine learning model using both the structured data and unstructured data can be compared.

In one or more embodiments, a system and method can automatically or semi-automatically improve feature engineering for an automated machine learning pipeline (and/or semi-automated machine learning pipeline) using structured and unstructured sources of data. For example, the system and/or method can enhance features from unstructured data, which can be associated with structured data. For instance, in an embodiment, a processor may identify the most important features/concepts from a first source of the data, for example, based on domain knowledge, user input and/or a preliminary model evaluation. The processor may identify documents from a corpus based on the following: If documents are directly available for the related concept, the processor may use those available documents; If there exists an ontology, or a concept map (also referred to as a concept graph), the processor may traverse the concept graph to find related concepts and collect documents related to those concepts; If there is no concept map available, the processor may create a concept map based on a seed corpus like Wikipedia, and traverse the concept map, as above, and extract documents.

The processor may extract one or more features from the documents identified above, using natural language processing techniques such as classification, sentiment analysis, event extraction, and/or others. The processor may merge the extracted features with the model development flow. In an embodiment, merging the extracted features can include adding to or replacing the original feature with one or more of the new extracted features. In another embodiment, merging the extracted features can include filling in the missing pieces of the information in the original feature definition, missing temporal or spatial information.

A method of enhancing features can include identifying the features of interest from the unstructured data, identifying related data sources based on concept mapping, enhancing feature sets in one or more ways, e.g., disambiguating structured source data using NLP, e.g. helping distinguish data for two different cities, when only the combination is given, identifying data sources base on selected feature using concept-based search of structured data.

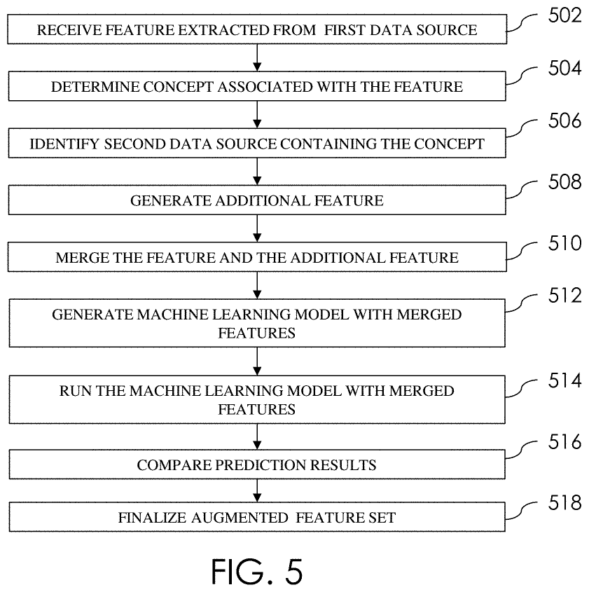

FIG. 5 is a flow diagram illustrating a method in an embodiment. The method can be run or implemented on one or more processors such as computer processors, e.g., coupled with one or more memory devices. At 502, a feature extracted from a first data source is received. The feature is used in a first machine learning model, which is built to predict an outcome. The feature extracted from a first data source can be determined based on importance of the feature to the first machine learning model's prediction outcome. An example of a machine learning model can be a neural network model or a deep learning model. Other machine learning models can be built. In an embodiment, the first data source includes structured data source.

At 504, a concept associated with the feature is determined by traversing a concept graph. The concept graph can be a data structure including nodes and edges connecting the nodes which are related. A node represents a concept, and an edge represents a relationship between two nodes the edge connects. In an embodiment, the concept graph can be automatically generated, e.g., if a concept graph associated with the feature is not available.

At 506, a second data source containing the concept associated with the feature can be identified. In an embodiment, the second data source includes unstructured data source. For example, social media, news and/or other databases can be searched for documents that contain reference to the concept.

At 508, an additional feature can be generated by performing a natural language processing on the second data source. For instance one or more variables refer to in the unstructured data source (e.g., a text document) and associated values can be extracted using a natural language processing technique.

At 510, the feature and the additional feature can be merged. In an embodiment, merging can include filling-in a missing information associated with the feature based on the additional feature. In another embodiment, merging can include replacing the feature with the additional feature. In yet another embodiment, merging can include adding the additional feature to the feature set.

At 512, a second machine learning model can be generated for predicting the outcome using the merged feature. For instance, the second machine learning model is for addressing the same problem as the first machine learning model. For example, if the first machine learning model is to predict a city's or locale's growth, the second machine learning model is built also to predict the city's or locale's growth. Generating a second machine learning model can include training the second machine learning model based on a training set augmented with a plurality of data values associated with the merged feature.

At 514, the second machine learning model is run. At 516, a prediction result of the first machine learning model can be compared with a prediction result of the second machine learning model relative to ground truth data, to evaluate effectiveness of the merged features. For instance, it can be determined whether the first machine learning model's prediction result or the second machine learning model's prediction result is closer to the ground truth data in an out of sample test. If the second machine learning model's prediction result is closer to the ground truth data, it can be determined that the merged feature is effective. At 518, based on determining that the merged feature is effective or not, it can be determined whether to augment the feature with the merged feature in machine learning. For instance, if the merged feature is effective, the feature can be augmented using the merged feature for building a machine learning model for making a desired prediction.

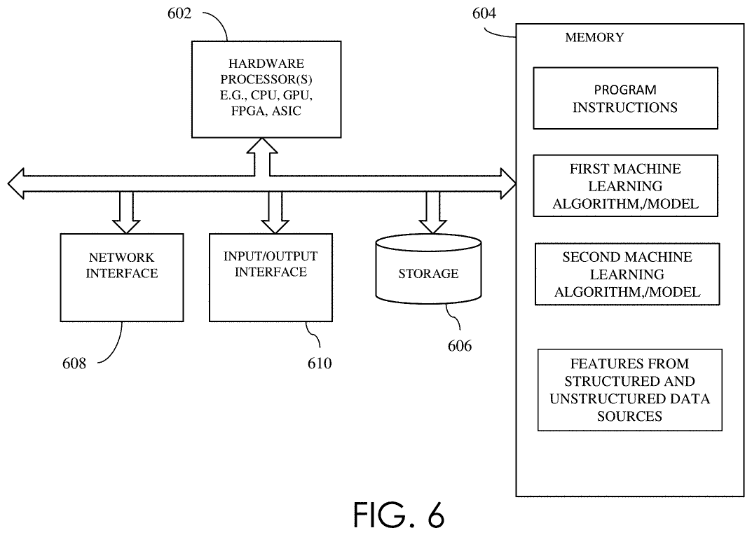

FIG. 6 is a diagram showing components of a system in one embodiment that perform feature engineering in a machine learning pipeline. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and generate a prediction model and recommend communication opportunities. A memory device 604 may include random access memory (RAM), read-only memory (ROM) or another memory device, and may store data and/or processor instructions for implementing various functionalities associated with the methods and/or systems described herein. One or more processors 602 may execute computer instructions stored in memory 604 or received from another computer device or medium. A memory device 604 may, for example, store instructions and/or data for functioning of one or more hardware processors 602, and may include an operating system and other program of instructions and/or data.

One or more hardware processors 602 may receive input including a feature, for example, extracted from a first data source such as a structured data source, and used in a machine learning model. At least one hardware processor 602 may determine a concept associated with the feature by traversing a concept graph. At least one hardware processor 602 may identify a second data source containing the concept associated with the feature. At least one hardware processor 602 may generate an additional feature by performing a natural language processing on the second data source. At least one hardware processor 602 may merge the feature and the additional feature. At least one hardware processor 602 may generate a second machine learning model for predicting the outcome using the merged feature. At least one hardware processor 602 may run the second machine learning model. At least one hardware processor 602 may compare a prediction result of the first machine learning model with a prediction result of the second machine learning model relative to ground truth data, to evaluate effective of the merged feature. At least one hardware processor 602 may, based on the evaluated effectiveness, determine whether to augment the feature with the merged feature in machine learning. At least one hardware processor 602 may augment the feature, for example, with the merged feature or the additional feature.

Data processed or used by at least one hardware processor 602 may be stored in a storage device 606 or received via a network interface 608 from a remote device, and may be temporarily loaded into a memory device 604 for performing feature engineering. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

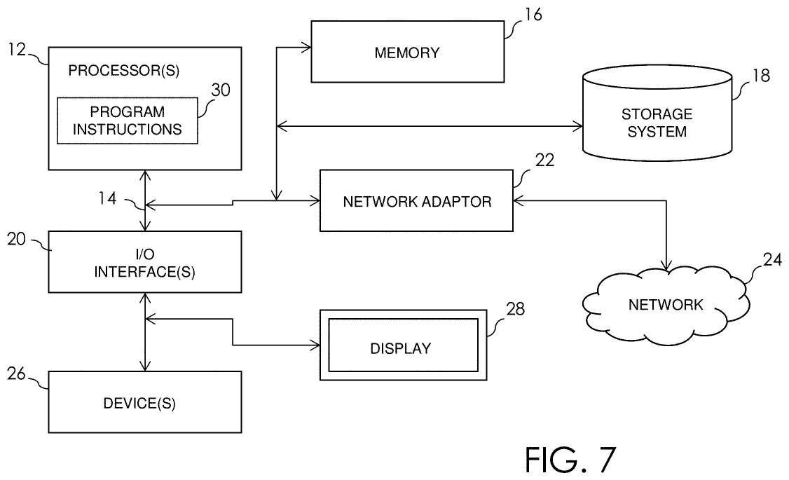

FIG. 7 illustrates a schematic of an example computer or processing system that may implement a system in one embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being run by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

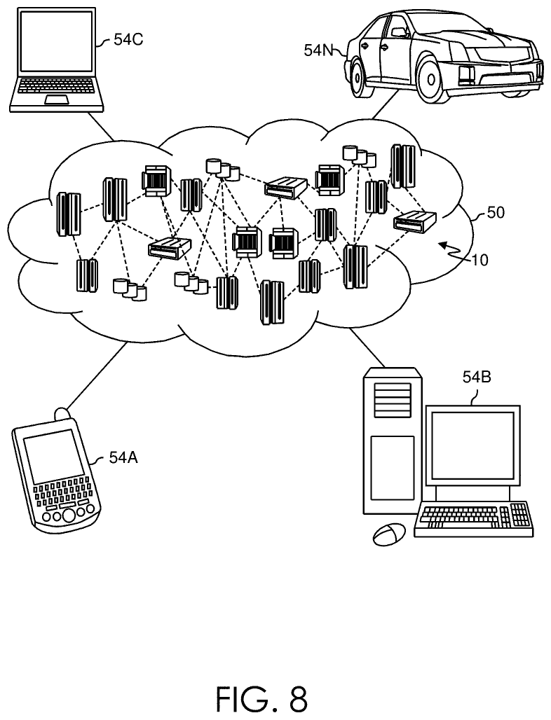

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

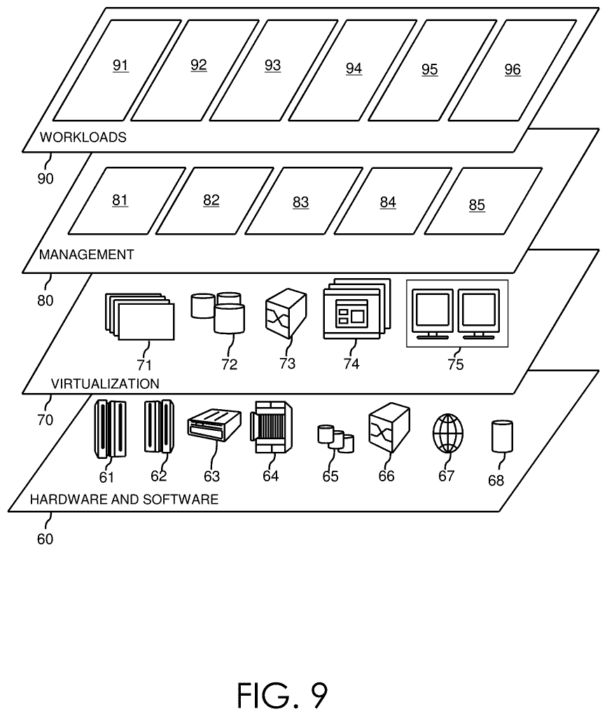

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and feature engineering processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for feature engineering in a machine learning pipeline, comprising:
a processor;
a memory device coupled with the processor;
the processor configured to at least:
receive a feature extracted from a first data source, the feature used in a first machine learning model, the first machine learning model built to predict an outcome;
determine a concept associated with the feature by traversing a concept graph;
identify a second data source containing the concept associated with the feature;
generate an additional feature by performing a natural language processing on the second data source;
merge the feature and the additional feature;
generate a second machine learning model for predicting the outcome using the merged feature;
run the second machine learning model;
compare a prediction result of the first machine learning model with a prediction result of the second machine learning model relative to ground truth data, to evaluate effective of the merged feature; and
based on the evaluated effectiveness, augment the feature using the merged feature in machine learning.

2. The system of claim 1, wherein, to merge the feature and the additional feature, the processor is configured to fill-in a missing information associated with the feature based on the additional feature.

3. The system of claim 1, wherein, to merge the feature and the additional feature, the processor is configured to replace the feature with the additional feature.

4. The system of claim 1, wherein, to merge the feature and the additional feature, the processor is configured to add the additional feature to the feature.

5. The system of claim 1, wherein the processor is further configured to automatically generate the concept graph responsive to determining that the concept graph associated with the feature is not available.

6. The system of claim 1, wherein the first data source includes structured data source.

7. The system of claim 1, wherein the second data source includes unstructured data source.

8. The system of claim 1, wherein, to generate a second machine learning model, the processor is configured to train the second machine learning model based on a training set augmented with a plurality of data values associated with the merged feature.

9. The system of claim 1, wherein the processor is configured to determine the feature extracted from a first data source based on importance of the feature to the first machine learning model's outcome.

10. A method of feature engineering in a machine learning pipeline, comprising:
receiving a feature extracted from a first data source, the feature used in a first machine learning model, the first machine learning model built to predict an outcome;
determining a concept associated with the feature by traversing a concept graph;
identifying a second data source containing the concept associated with the feature;
generating an additional feature by performing a natural language processing on the second data source;
merging the feature and the additional feature;
generating a second machine learning model for predicting the outcome using the merged feature;
running the second machine learning model;
comparing a prediction result of the first machine learning model with a prediction result of the second machine learning model relative to ground truth data, to evaluate effective of the merged feature; and
based on the evaluated effectiveness, augmenting the feature using the merged feature in machine learning.

11. The method of claim 10, wherein the merging of the feature and the additional feature includes filling-in a missing information associated with the feature based on the additional feature.

12. The method of claim 10, wherein the merging of the feature and the additional feature includes replacing the feature with the additional feature.

13. The method of claim 10, wherein the merging of the feature and the additional feature includes adding the additional feature to the feature.

14. The method of claim 10, further including automatically generating the concept graph responsive to determining that the concept graph associated with the feature is not available.

15. The method of claim 10, wherein the first data source includes structured data source.

16. The method of claim 10, wherein the second data source includes unstructured data source.

17. The method of claim 10, wherein generating a second machine learning model include training the second machine learning model based on a training set augmented with a plurality of data values associated with the merged feature.

18. The method of claim 10, wherein the feature extracted from a first data source is determined based on importance of the feature to the first machine learning model's prediction outcome.

19. A computer program product comprising a computer readable storage medium having program instructions embodied therewith, the program instructions readable by a device to cause the device to:
receive a feature extracted from a first data source, the feature used in a first machine learning model, the first machine learning model built to predict an outcome;
determine a concept associated with the feature by traversing a concept graph;
identify a second data source containing the concept associated with the feature;
generate an additional feature by performing a natural language processing on the second data source;
merge the feature and the additional feature;
generate a second machine learning model for predicting the outcome using the merged feature;
run the second machine learning model;
compare a prediction result of the first machine learning model with a prediction result of the second machine learning model relative to ground truth data, to evaluate effective of the merged feature; and
based on the evaluated effectiveness, augment the feature using the merged feature in machine learning.

20. The computer program product of claim 19, wherein the device is caused to automatically generate the concept graph responsive to determining that the concept graph associated with the feature is not available.
